(19) United States
(12) Patent Application Publication
(10) Pub. No.: US 2025/0121352 A1
(43) Pub. Date: Apr. 17, 2025

(54) BURNT AND GRANULATED CLAY AND METHOD FOR MANUFACTURING SAME

(71) Applicant: SOLTI Corporation, Gumma (JP)

(72) Inventor: Hitome Samantha NAKAMURA, Gumma (JP)

(73) Assignee: SOLTI Corporation, Gumma (JP)

(21) Appl. No.: 18/951,552

(22) Filed: Nov. 18, 2024

Related U.S. Application Data
(63) Continuation-in-part of application No. 17/288,953, filed on Apr. 27, 2021, now abandoned.

(51) Int. Cl. B01J 20/12; B01J 20/28; B01J 20/30; C02F 1/28; C02F 1/42; C02F 101/10; C02F 101/16; C02F 101/30

(52) U.S. Cl. CPC B01J 20/12; B01J 20/28004; B01J 20/28011; B01J 20/28016; B01J 20/28059; B01J 20/28071; B01J 20/28083; B01J 20/3014; B01J 20/3028; B01J 20/3078; C02F 1/281; C02F 1/42; C02F 2001/425; C02F 2101/105; C02F 2101/16; C02F 2101/308

(57) ABSTRACT

A granulated sintered clay is provided. The granulated sintered clay with aggregate structures is porous with micropores and mesopores and has high hardness that does not collapse even in water. The granulated sintered clay has a differential pore volume with a pore diameter of 10 nm or less of 0.06 cm³/g or more in a pore distribution curve measured by a nitrogen gas adsorption method, a hardness to collapse at a planar load of 180 gf to 1200 gf in a crushing test, and a silicon dioxide content of 35 mass % to 95 mass %.

### CROSS REFERENCE TO RELATED APPLICATION

This is a Continuation-In-Part application claiming priority to U.S. patent application Ser. No. 17/288,953 and foreign priority to Japanese Patent Application No. 2018-219718 filed on Nov. 6, 2018. This application also refers to JP Patent Application No. 2014-93594, filed on Apr. 30, 2014, corresponding to Japanese Patent Publication No. 2015-109823 in PLT 1 below. The contents of U.S. patent application Ser. No. 17/288,953. Japanese Patent Application No. 2018-219718. and Japanese Patent Publication No. 2015-109823 are hereby incorporated by reference in their entireties.

### TECHNICAL FIELD

The present invention relates to granulated sintered clay, and a method of manufacturing the granulated sintered clay.

### BACKGROUND ART

In general, sintered soil is mainly used for the cultivation of plants (PTLs 1 to 3). For example, PTL 1 discloses sintered soil suitable for agricultural soil and horticultural soil, where the sintered soil has superior characteristics in air permeability, water retention, fertilizer retention, and shape retainability, and no obstruction to the growth of plants.

### CITATION LIST

### Patent Literatures

PTL 1: JP 2015-109823A
PTL 2: JP 2018-113887A
PTL 3: JP 2004-121066A

### SUMMARY

### Problems to be Solved

Although the sintered soil disclosed in PTL 1 has sufficiently high hardness for use on land, the soil starts to collapse within about three months in water.

### Means for Solving Problems

The present inventors have made intensive studies to produce granulated sintered clay that barely collapse in water and barely generates turbid water. In these studies, a raw clay material has been kneaded and refined without addition of fine powder soil to the raw clay material and a portion of silicon dioxide contained in the raw clay material is sintered for vitrification. As a result, porous granulated sintered clay having more well-formed micropores, mesopores and nanopores has been completed. This clay has high hardness and thus high shape retainability in water. The inventors have also found that the granulated sintered clay has functions to improve water quality, purify water, and prevent water-contamination.

The present technology provides granulated sintered clay with aggregate structures that has a differential pore volume with a pore diameter of 10 nm or less of 0.06 cm³/g or more in a pore distribution curve measured by a nitrogen gas adsorption method, a hardness to collapse at a planar load of 180 gf to 1200 gf in a crushing test, and a silicon dioxide content of 35 mass % to 95 mass %, and some portions of the silicon dioxide are vitrified, and the fine powder soil is not added to the raw clay material.

The granulated sintered clay in the present technology preferably has specific surface area of 80 m²/g or more with through-pores and a mean particle diameter of 0.075 mm to 9.5 mm as measured in accordance with Japanese Industrial Standards (JIS) A 1204: 2009, and has a calcium oxide content of 2000 mg/kg or more, a magnesium oxide content of 250 mg/kg or more, and a cation exchange capacity of 10 cmol_{c}/kg or more. In addition, the granulated sintered clay in the present technology may include at least one material selected from the group consisting of plant activators, grains, plant residues, food residues, wastewater residues, nucleic acids, iron sulfate, oyster shells, scallop shells, baking soda, oil residues, soybean flour, rock salt, sea salt, spices (e.g., cinnamon), cacao, coffee, fragrances (e.g., fragrant wood), aroma oils, charcoal, peat moss, coco peat, corn cobs, vermiculite, pearlite, clay powder (e.g., kaolin), various minerals (e.g., illite, mica, silica, calcium carbonate, and powder such as rocks and gravel), fulvic acid, fumic acid, microorganisms such as nitrifying yeast, and microbial extracts (e.g., enzymes).

The present technology provides a method of manufacturing granulated sintered clay, the method comprises the steps of:
kneading a raw clay material, without adding the fine powder soil, being having a silicon dioxide content of 35 mass % to 95 mass % when the granulated sintered clay is manufactured to homogenize particles of the clay until the raw clay material exhibits a smooth surface;
removing the agglomerates separated or generated during the step of kneading to refine the raw clay material;
granulating the refined raw clay material through dry-granulation to form aggregate structures; and
heating the granulated clay material to 400° C. to 1000° C. to vitrify some portions of the silicon dioxide in the raw clay material he silicon dioxide.

The present technology also provides a water-quality improving agent, a water purifying agent, and a water-contamination inhibiting agent containing the granulated sintered clay, and also provides a water-quality improving device or a water cleaning device having a module including the water-quality improving agent or the water purifying agent in a container, and a cultivation or culture system having such devices.

The volume of water existing on the earth is known to be about 1.4 billion km³. Of this water, seawater accounts for about 97.5% and freshwater accounts for about 2.5%. Most of the freshwater is present in the form of ice and glaciers on, for example, the Antarctic and Arctic regions, and the volume of freshwater, such as groundwater, rivers, lakes or marshes, is about 0.8% of the water on the earth. Most of the about 0.8% of water is present in the form of groundwater, and the volume of freshwater in rivers, lakes or marshes is only about 0.01% of the volume of water that exists on the earth, i.e., 0.1 million km³ (cited from “Current status of water resources in Japan: Chapter 1, Status of water circulation and available quantity of water resources in Japan” from website of Ministry of Land, Infrastructure, Transport and Tourism).

The main source of water used by humankind is freshwater from rivers, which is originated from rainwater that falls from the sky. Rain cloud, which is generated in the atmosphere by evapotranspiration of water from the sea and land, forms rainfall. The rain that falls on the ground from the sky makes rivers and groundwater, and eventually returns to the sea. The seawater again evaporates into the atmosphere, and generates cloud to subsequently rain. Some portions of the rain that falls on the ground is sucked up by plants and transpired into the atmosphere from, for example, leaves, resulting in one of the mechanisms for cloud formation. In this way, the water on the earth has circulated since ancient times, and the total volume of water has substantially unchanged (cited from “Water circulation” that supports daily life from website of Government public relations).

Rainwater contains substances, such as sulfur oxide, nitrogen oxide, dust, and dirt. The rainwater is filtered through the gaps among the soil particles, and nitrogen and phosphorus contained in the rainwater are ingested and removed by microorganisms in the soil. In addition, calcium ions in the soil are exchanged with hydrogen ions in the rainwater, and the rainwater changes from weak acidic to neutral. The rainwater is further finely filtered through the layers of sand and pebbles beneath the soil (Cited from “History of Evian Water; a very small amount of water circulating on the earth can be used by mankind” from Danone Japan Co., Ltd.).

The granulated sintered clay in this technology has the same function as the layers of soil, sand and pebbles that can filter the rainwater into clean water or mineral water. In other words, the water-quality improving device or the water cleaning device and the system having these devices in the present technology can artificially and readily achieve the purification process performed with soil in the water circulation on the earth. Needless to say, the water-quality improving device or the water cleaning device and the system having these devices in the present technology can be used for purification all of clean water, reclaimed water, and waste water. In addition, the granulated sintered clay in the present technology contains various cations, such as calcium, magnesium, potassium, and sodium; hence, the clay can be used not only for production of mineral water but also for application to agricultural soil or soil to treat manure from animals.

The advantageous effects described above may be, but not necessarily limited, any of the advantageous effects described in the present specification.

### effects of the Invention

The present technology can provide granulated sintered clay that barely collapse even in water. The granulated sintered clay has a large number of through-micropores and through-mesopores, and can adsorb to retain impurities containing in water. Since the granulated sintered clay can be produced without containing any artificial chemical substance, such clay is very friendly to the natural environment.

The advantageous effects described above may be, but not necessarily limited, any of the advantageous effects described in the present specification.

### BRIEF DESCRIPTIONS OF DRAWINGS

FIG. 1 includes photographs illustrating electron microscopic images of particles given through granulation and air-drying of raw clay material.

FIG. 2 includes photographs illustrating electron microscopic images of granulated sintered clay sintered at 500° C.

FIG. 3 includes photographs illustrating electron microscopic images of granulated sintered clay sintered at 650° C.

FIG. 4 includes photographs illustrating electron microscopic images of granulated sintered clay sintered at 750° C.

FIG. 5 includes photographs illustrating electron microscopic images of commercially available product A.

FIG. 6 includes photographs illustrating electron microscopic images of commercially available product B.

FIG. 7 is a photograph illustrating appearances after a granulated sintered clay sintered at 750° C. in the present technology, a granulated sintered clay for agricultural use, and a commercially available granulated soil for agricultural use were left in water for 140 days.

FIG. 8 is a photograph illustrating the adsorption of methylene blue after the granulated sintered clay sintered at 750° C. was left for two days.

FIG. 9 is a photograph illustrating the desorption of methylene blue after the granulated sintered clay sintered at 750° C. was left for five days and then shaken.

FIG. 10 is a photograph illustrating an exemplary water cleaning device.

FIG. 11 is a photograph illustrating water purified by a water cleaning device.

FIG. 12 includes photographs illustrating the removal of blue-green algae.

FIG. 13 is a photograph illustrating a lotus field where blue-green algae grew.

FIG. 14 is a photograph illustrating a lotus field after blue-green algae were removed.

FIG. 15 is a schematic diagram of the cross-section of a single piece of the granulated sintered clay.

FIG. 16 is a schematic diagram showing a 1000× magnification of a cross-section of the granulated sintered clay.

FIG. 17 is an enlarged schematic diagram of the area around a single clay particle of the granulated sintered clay.

FIG. 18 is a photograph illustrating the granulated sintered clay in a dried state before immersion in water. The granulated sintered clay before hardness measurement is shown at the top, and the granulated sintered clay after hardness measurement is shown at the bottom.

FIG. 19 is a photograph illustrating the granulated sintered clay that has been immersed in room-temperature water for 168 hours. The granulated sintered clay before the hardness measurement is shown at the top, and the granulated sintered clay after the hardness measurement is shown at the bottom.

FIG. 20 is a photograph illustrating the granulated sintered clay that has been immersed in room-temperature water for 10 years. The granulated sintered clay before the hardness measurement is shown at the top, and the sintered granulated clay after the hardness measurement is shown at the bottom.

FIG. 21 is a photograph illustrating the water tank containing the granulated sintered clay that has been immersed in water for 10 years.

FIG. 22 is a photograph illustrating the appearance of the granulated sintered clay that has been immersed in water for 10 years, scooped up by hand in the water tank.

FIG. 23 is a photograph illustrating the appearance of the granulated sintered clay that has been immersed in water for 10 years being crushed with fingers in the water tank.

FIG. 24 is a photograph illustrating the granulated sintered clay immediately after immersion in water.

FIG. 25 is a photograph illustrating the appearance of the granulated sintered clay scooped up with the hands immediately after immersion in water.

FIG. 26 is a photograph illustrating the appearance of the granulated sintered clay immediately after immersion in water, when it is being crushed with fingers.

### EMBODIMENTS OF THE INVENTION

### Definition

Unless otherwise defined herein, scientific and technical terms used in connection with the present application shall have the meanings that are commonly understood by those of ordinary skill in the art. Further, unless otherwise required by context, singular terms shall include pluralities and plural terms shall include the singular.

It should be understood that this invention is not limited to the particular methodology, protocols, and reagents, etc., described herein and as such may vary. The terminology used herein is for the purpose of describing particular embodiments only, and is not intended to limit the scope of the present invention, which is defined solely by the claims.

As used herein, the articles “a,” “an,” and “the” are used herein to refer to one or to more than one (i.e., to at least one) of the grammatical object of the article. By way of example, “an element” means one element or more than one element.

The use of the alternative (e.g., “or”) should be understood to mean either one, both, or any combination thereof of the alternatives.

The term “and/or” should be understood to mean either one, or both of the alternatives.

As used herein, the term “about” or “approximately” refers to a quantity, level, value, number, frequency, percentage, dimension, size, amount, weight or length that varies by as much as 15%, 10%, 9%, 8%, 7%, 6%, 5%, 4%, 3%, 2% or 1% compared to a reference quantity, level, value, number, frequency, percentage, dimension, size, amount, weight or length. In one embodiment, the term “about” or “approximately” refers a range of quantity, level, value, number, frequency, percentage, dimension, size, amount, weight or length ±15%, ±10%, ±9%, ±8%, ±7%, ±6%, ±5%, ±4%, ±3%, ±2%, or ±1% about a reference quantity, level, value, number, frequency, percentage, dimension, size, amount, weight or length.

As used herein, the term “substantially” or “essentially” refers to a quantity, level, value, number, frequency, percentage, dimension, size, amount, weight or length that is about 90%, 91%, 92%, 93%, 94%, 95%, 96%, 97%, 98%, or 99% or higher compared to a reference quantity, level, value, number, frequency, percentage, dimension, size, amount, weight or length. In one embodiment, the terms “essentially the same” or “substantially the same” refer a range of quantity, level, value, number, frequency, percentage, dimension, size, amount, weight or length that is about the same as a reference quantity, level, value, number, frequency, percentage, dimension, size, amount, weight or length.

Throughout this specification, unless the context requires otherwise, the words “comprise,” “comprises” and “comprising” will be understood to imply the inclusion of a stated step or element or group of steps or elements but not the exclusion of any other step or element or group of steps or elements. In particular embodiments, the terms “include,” “has,” “contains,” and “comprise” are used synonymously.

By “consisting of” is meant including, and limited to, whatever follows the phrase “consisting of.” Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that no other elements are optional and may or may not be present depending upon whether or not they affect the activity or action of the listed elements.

Reference throughout this specification to “one embodiment,” “an embodiment,” “a particular embodiment,” “a related embodiment,” “a certain embodiment,” “an additional embodiment,” or “a further embodiment” or combinations thereof means that a particular feature, structure or characteristic described in connection with the embodiment is included in at least one embodiment of the present invention. Thus, the appearances of the foregoing phrases in various places throughout this specification are not necessarily all referring to the same embodiment. Furthermore, the particular features, structures, or characteristics may be combined in any suitable manner in one or more embodiments.

As used herein, the term “clay” refers to sediments made of very fine particles and containing silicon dioxide (SiO₂). The definition of “clay” is based primarily on mineralogical properties in the International Clay Conference (ICC).

Mineralogically, clay can be described as a group of minerals comprised of silicon oxygen tetrahedra (SiO₄) linked in layers. For example, kaolinite, montmorillonite, illite, or chlorite clay are included in clays. The particle size of clay is generally defined as fine particles of two microns (0.002 mm) or less. Clay has the following characteristics:
(1) clay has plasticity when it contains water and has the ability to change its shape and retain it,
(2) clay can easily absorb water and swell as a result,
(3) clay has a high cation exchange capacity due to its layered structure,
(4) clay is formed mainly by weathering and hydrothermal metamorphism,
(5) fine minerals in clay are formed by weathering and chemical decomposition of rocks, etc.

As used herein, “granulated sintered clay” refers to clay that is artificially produced by granulation and sintering has a structure in which clay particles are aggregated and the aggregated clay particles are further aggregated.

The granulated sintered clay is produced by a manufacturing process including the following steps:
(1) a raw clay kneading process
(2) a raw clay refining process,
(3) a granulation process in which the refined raw clay is dried and granulated, and
(4) a vitrifying process that vitrifies a part of silicon dioxide contained in the clay.

“Granulated sintered clay” does not include clay in which substantially all of the silicon dioxide has been vitrified. Examples of substantially wholly vitrified silicon dioxide include “ceramic” and “silica balls”.

When used herein, the term “aggregate structure” refers to a structure formed by aggregation of clay particles to form the primary aggregates and aggregation of the primary aggregates to form the secondary aggregates. The secondary aggregates have micropores, mesopores, nanopores, etc., and the primary aggregates have even smaller pores.

As used herein, “fine powder soil” means finely powdered soil produced in the manufacture of the granulated sintered clay. Example include the fine powder soil produced in the drying and granulation process of raw clay, fine powder soil produced by granulation treatment after the drying and granulation process, and fine powder soil under a sieve obtained in the sifting process to sort by size. The fine powder soil, for example, has a particle size of 0.05 to 2.0 mm, and average particle size of about 0.7 mm.

When used herein, the term “nanopore” refers to a pore with a diameter of a few centimeters or less. In accordance with the classification of the International Union of Pure and Applied Chemistry (IUPAC), pores with a diameter of 2.0 nm or less are referred to as micropores, pores with a diameter of 2.0 nm to 50 nm are referred to as mesopores, and pores with a diameter of 50 nm or more are referred to as macropores.

### Granulated Sintered Clay

The granulated sintered clay in the present technology contains silicon dioxide in a content of 35 mass % to 95 mass %. Some portions of silicon dioxide contained in the raw clay material converts into vitrified silicon dioxide through sintering. A larger content of the silicon dioxide in the granulated sintered clay results in formation of more pores between adjacent vitrified silicon dioxide ingredients, or between vitrified silicon dioxide and other ingredients of granulated sintered clay. A silicon dioxide content less than 35 mass % in the granulated sintered clay cannot lead to formation of sufficient pores, resulting in a low differential pore volume or small specific surface area. A silicon dioxide content beyond 95 mass % in the granulated sintered clay results in high hardness of the granulated sintered clay, but the granulated sintered clay may barely retain water therein after left in water. The granulated sintered clay accordingly has a silicon dioxide content of preferably 40 mass % to 70 mass %, more preferably 50 mass % to 60 mass %.

The granulated sintered clay in the present technology has a differential pore volume with a pore diameter of 10 nm or less of 0.06 cm³/g or more in a pore distribution curve as measured by a nitrogen gas adsorption method. A noticeably large number of micropores and mesopores can absorb to retain substances in water. The granulated sintered clay more preferably has a differential pore volume with a pore diameter of 4 nm or less of 0.08 cm³/g or more.

The granulated sintered clay in the present technology has a hardness to collapse at a planar load of 180 gf to 1200 gf in a crushing test. A hardness of 180 gf or more does not cause the granulated sintered clay to readily lose its shape even when left in water for a long time. The granulated sintered clay more preferably has a hardness to collapse at a planar load of 225 gf or more. A hardness of above 1200 gf does not cause the granulated sintered clay to readily absorb water because the clay has a shape like a silica ball. The granulated sintered clay more preferably has a hardness of 240 gf or less. The granulated sintered clay disclosed in PTL 1 collapses at a planar load of 100 gf or less.

The granulated sintered clay in the present technology preferably has a specific surface area of 80 m²/g or more. The granulated sintered clay in the present technology is formed through granulation of clay material and has an aggregate structure and a large number of micropores and mesopores, resulting in a remarkably large specific surface area, and thereby the granulated sintered clay can adsorb and retain large amounts of substances in water. The granulated sintered clay has a specific surface area of more preferably 100 m²/g or more, further more preferably 140 m²/g or more.

The pores such as micropores and mesopores preferably extend through the particles of granulated sintered clay. When the granulated sintered clay is immersed into water, oxygen contained in the granulated sintered clay is released into the water. Even after the released oxygen is consumed by aquatic plants and aquatic organisms, the oxygen contained in another water flow is trapped into the granulated sintered clay, and the trapped oxygen is released from the granulated sintered clay into the water. This mechanism is repeatedly circulated. The granulated sintered clay in the present technology has a very large number of through-micropores and through-mesopores and has a large specific surface area; hence, the impurities in water can be adsorbed and the oxygen can be trapped when the clay is put into water of, for example, eutrophicated or polluted lakes and rivers. The process of forming through-pores is speculated as follows: when the raw clay material is granulated and sintered, silicon dioxide contained in the raw clay material is formed into the particles of silicon dioxide which is partially vitrified; such particles stack three-dimensionally to form three-dimensional pores; and the three-dimensional pores are connected in a network structure pattern to form through-pores. Accordingly, the granulated sintered clay in the present technology also has a filtering function.

The granulated sintered clay in the present technology preferably has a mean particle diameter of 0.075 mm to 9.5 mm as measured in accordance with JIS A 1204: 2009. Such a range results in a large specific surface area. The granulated sintered clay has a mean particle diameter of more preferably 0.5 mm to 5 mm, further more preferably 1 mm to 4 mm.

The granulated sintered clay in the present technology preferably has a calcium oxide content of 2000 mg/kg or more. A larger content of calcium oxide causes the exchange of calcium ions with hydrogen ions in water to adjust the pH of water, and can improve the function of water purification and produce mineral water. The granulated sintered clay more preferably has a calcium oxide content of 2500 mg/kg or more.

The granulated sintered clay in the present technology preferably has a magnesium oxide content of 250 mg/kg or more. A larger content of magnesium oxide causes the exchange of magnesium ions with hydrogen ions in water to adjust the pH of water, and can improve the function of water purification and produce mineral water. The granulated sintered clay more preferably has a magnesium oxide content of 300 mg/kg.

The granulated sintered clay in the present technology preferably has a cation exchange capacity of 10 cmol_{c}/kg or more (dry soil). A Larger cation exchange capacity can promote adsorption and retention of the cations of various elements, such as ammonium nitrogen, calcium, magnesium, potassium, and sodium. Specifically, a cation exchange capacity of 10 cmol_{c}/kg or more can promote adsorption and retention of the cations in water when the granulated sintered clay is used for an improvement in water quality or water purification, and of the ingredients of applied fertilizer when the granulated sintered clay is used in an agricultural or horticultural field. The granulated sintered clay has a cation exchange capacity of more preferably 15 cmol_{c}/kg or more, further more preferably 20 cmol_{c}/kg or more. An increase in the cation exchange capacity can be achieved by addition of silicon into the raw clay material.

The granulated sintered clay in the present technology preferably has a pH of 3.5 to 9.0. Such a range can cause most plants to grow. The granulated sintered clay preferably has a pH of 4.0 to 8.0 in use for an improvement in water quality or water purification, or in use in the agricultural or horticultural field.

The granulated sintered clay in the present technology may include at least one material selected from the group consisting of plant activators, grains, plant residues, food residues, wastewater residues, nucleic acids, iron sulfate, oyster shells, scallop shells, baking soda, oil residues, soybean flour, rock salt, sea salt, spices (e.g., cinnamon), cacao, coffee, fragrances (e.g., fragrant wood), aroma oils, charcoal, peat moss, coco peat, corn cobs, vermiculite, pearlite, clay powder (e.g., kaolin), various minerals (e.g., illite, mica, silica, calcium carbonate, and powder such as rocks and gravel), fulvic acid, fumic acid, microorganisms such as nitrifying bacteria and yeast, and yeast extracts (e.g., enzymes). Examples of the plant activators include Narihira enzyme™ (registered trademark) and Manda enzyme™ (registered trademark) for plants. Narihira enzyme™ (registered trademark) is a plant-active enzyme extracted from a mushroom culture. Manda enzyme™ is an enzyme obtained through fermentation and maturation of more than 53 raw materials including fruits, grains, algae, and vegetables. The rock salt and sea salt contain sodium, and have herbicidal effects and weed inhibiting effects. The cinnamon, cacao and coffee can be expected to have the effects for reducing the pungency of vegetables in vegetable cultivation. The fragrances and aroma oils can be expected to have insect repellent effects. The fulvic acid and humic acid can promote the growth of living organisms. Some organic substances, such as nitrifying bacteria, grains, and food residues, have an action of nitrification and denitrification of ammonia, and can eliminate ammonia in water. Since the granulated sintered clay can be used for an improvement in water quality, water purification, an improvement in soil, and organic cultivation of plants, the additives described above are preferably naturally derived materials rather than chemicals.

In particular, the granulated sintered clay containing a large amount of iron can efficiently remove, for example, phosphate ions, nitrate ions, nitrite ions from water in use for purification of water containing, for example, chemical fertilizers. Examples of the iron form include, but not limited to, powdered iron sulfate.

The granulated sintered clay in the present technology can also be used in, for example, soil for aquacultural beds, soil for agriculture, plant growing agents, and soil conditioning agents. Specifically, the granulated sintered clay can be used in soil for aquacultural bed to breed and cultivate seawater fish, freshwater fish, crustaceans, shellfish, and seaweed such as Undaria, kelp, and sea grapes, and can be used in soil for agriculture to cultivate vegetables, fruits, grains, and flowers. For example, in the use of the granulated sintered clay of the present technology in the soil for agriculture, plants can be cultivated by simply replenishing water when the soil dries without the need for drainage. The replenishment preferably contains nanobubbles consisting of water and nutrients. Since the amount of soil can be adjusted depending on the cultivated plants, the granulated sintered clay can be applied to indoor agriculture, especially vertical farming. In the cultivation of plants in a container with a limited volume of soil, the earth pressure may be increased and the growth of plants may be hindered; hence, oxygen and hydrogen are preferably supplied to the granulated sintered clay in such cases.

### Method of Manufacturing Granulated Sintered Clay

A method of manufacturing granulated sintered clay in the present technology, comprising the steps of:
kneading a raw clay material, without adding the fine power soil, being a silicon dioxide content of 35 mass % to 95 mass % when the granulated sintered clay is manufacture to homogenize particles of the clay until the raw clay material exhibits a smooth surface;
removing the agglomerates separated or generated during the step of kneading to refine the raw clay material;
granulating the refined raw clay material through dry-granulation to form granules with an aggregate structure; and
heating the granulated clay material to 400° C. to 1000° C. to vitrify a portion of the silicon dioxide in the raw clay material.

The sintered granulated clay in the present technology can be returned to natural soil after several decades by leaving some of silicon dioxide contained in the raw clay material unvitrified.

### Raw Clay Material

A raw clay material contains silicon dioxide in a range of 35 mass % to 95 mass % when the granulated sintered clay is manufactured, preferably 40 mass % to 80 mass %, more preferably 45 mass % to 65 mass %. A silicon dioxide contents less than 35 mass % may cause a sufficient amount of vitrified silicon dioxide particles not to be formed after the raw clay material is granulated and sintered, resulting in reduced pores in the granulated sintered clay. A silicon dioxide content beyond 95 mass % may cause too large amount of vitrified silicon dioxide particles, resulting in low permeation of water into the sintered clay because the clay forms the shape like a silica ball. A silicon dioxide content can be adjusted as appropriate within the range described above, but it is preferred that the optimal amount is contained in a natural state. For example, the clay produced from the foot of Mt. Akagi in Takasaki City, Gunma Pref., Japan, which belongs to the Nasu volcanic belt, can be used as a raw clay material.

Preferably used is a raw clay material having a cation exchange capacity as high as possible. For example, preferred is a raw clay material having a capacity of 10 cmol/kg or more. In addition, any element such as calcium, magnesium, nitrogen, phosphorus, potassium, manganese, zinc, boron, and copper can be appropriately added depending on the purpose of use of the granulated sintered clay.

### Step of Kneading

The raw clay material is enough kneaded until the particles of the raw clay material are homogenized. In the manufacture of a raw clay material containing at least one additive selected from the group consisting of plant activators, grains, plant residues, food residues, wastewater residues, nucleic acids, iron sulfate, oyster shells, scallop shells, baking soda, oil residues, soybean flour, rock salt, sea salt, spices (e.g., cinnamon), cacao, coffee, fragrances (e.g., fragrant wood), aroma oils, charcoal, peat moss, coco peat, corn cobs, vermiculite, pearlite, clay powder (e.g., kaolin), various minerals (e.g., illite, mica, silica, calcium carbonate, and powder such as rocks and gravel), fulvic acid, fumic acid, microorganisms such as nitrifying bacteria and yeast, and yeast extracts, a step of kneading comprises adding an appropriate amount of preferably powdered additives to the raw clay material, and kneading the mixture with an appropriate amount of water.

### Step of Refinement of Raw Cray Material

In the case that the agglomerates of clay are mixed in the raw clay material, or formed during the step of kneading, the agglomerates should be removed. It is preferred to repeat the cycle involving collection of the remaining raw clay material, further kneading of the collected material, and removal of the formed agglomerates several times. The cycle consisting of the kneading and the refinement of the raw clay material is preferably repeated until the agglomerates are barely formed even after the raw clay material is kneaded and the raw clay material exhibits a smooth surface.

### Step of Granulation

In a step of granulation, it is not preferred that any chemical substance, such as a binder, is added to the raw clay material. A raw clay material free of chemical substances can be used in organic cultivation, safe purification and use of water, or restoration of water as it is to nature. The water content of the raw clay material (i.e., the water content as measured by a heating weight loss method) is adjusted into preferably 25 mass % to 55 mass %, more preferably 35 mass % to 50 mass %, further more preferably 42 mass % to 48 mass %, and the raw clay material is preferably granulated through dry-granulation.

The granulation can be performed through the supply of hot air at about 400° C. to 1000° C. from a heat generator with, for example, a rotary kiln. A higher rotation rate of the rotary kiln causes the granulation of small particles in a larger amount, and a lower rotation rate causes the granulation of large particles in a larger amount. A higher temperature of the hot air makes the particles smaller, and a lower temperature makes the particles larger. The granulation is carried out such that the granulated sintered clay after the following step of vitrification preferably has a mean particle diameter of 0.1 mm to 7 mm.

In addition, the granules produced in the granulation process are formed by the aggregation of clay particles, which are further aggregated to form a small aggregate structure. The aggregates also have well-ordered nano- and/or meso-pores, as well as through nano- and/or meso-pores. This structure allows them to be distinguished from other granulated clays and naturally occurring rocks.

### Step of Vitrification

After the step of granulation, the raw clay material of granules is further dried or sintered with, for example, a rotary kiln to vitrify some portions of the silicon dioxide contained in the raw clay material. The rotary kiln may be the same one used in the step of granulation or different one. In a step of vitrification, for example, hot air at 400° C. to 1000° C. is supplied for about 20 minutes. A temperature below 400° C. causes a prolonged drying time and increased cost. A temperature exceeding 1000° C. causes all the silicon dioxide in the raw clay material to convert into vitrified silicon dioxide particles, and may cause the raw clay material to form silica balls and decrease the water retainability. The raw cray material is dried and sintered at a temperature where some portions of silicon dioxide in the raw cray material is converted to vitrified silicon dioxide particles. The temperature of the hot air is more preferably 500° C. to 900° C.

### Other Steps

The vitrified clay is roughly cooled. At that time, since the granulated sintered clay may fuse with each other due to the fine powder soil on the surface of the granulated sintered clay, it may be processed in a granulator to remove the fine powder soil on the surface of the granulated sintered clay and to remove excess water on the surface.

An optional sieving step may be involved to sort granulated sintered clay by particle diameters. For example, the granulated sintered clay can be sieved into the groups of less than 0.9 mm, 0.9 mm to less than 1.8 mm, 1.8 mm to less than 3.0 mm, and 3.0 mm or more. The granulated sintered clay having a smaller particle diameter is not easily crushed even when pressed, has a large specific surface area, and has a high adsorption effect. The fine powder soil is produced under the sieve in the sifting process.

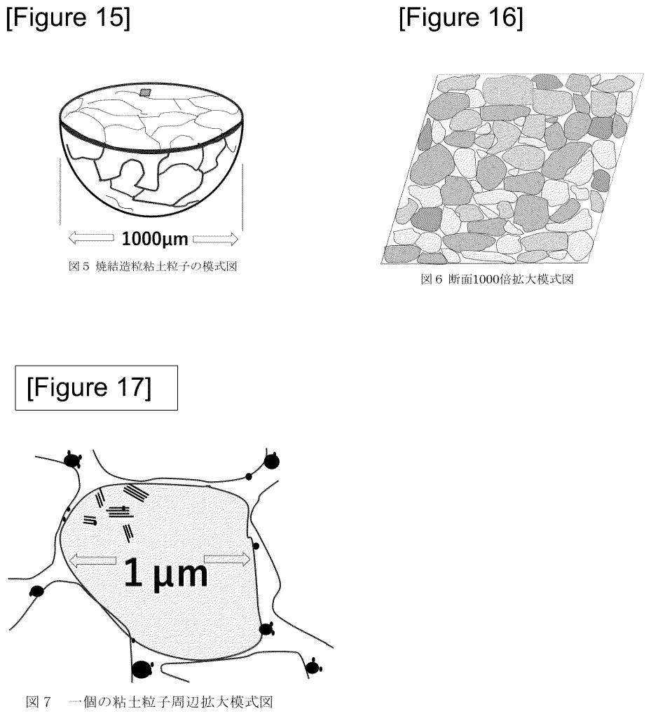

FIG. 15 shows a schematic diagram of the cross-section of a single piece of the granulated sintered clay with aggregate structure, diameter approx. 1 mm (1000 μm), manufactured using this technology. FIG. 16 shows a schematic diagram of a cross-section of the granulated sintered clay, magnified 1000 times. The clay particles coagulate and solidify evenly, but there are also gaps and voids between the particles, making it porous. Furthermore, FIG. 17 shows a magnified schematic diagram of the area around a clay particle.

In addition, the granulated sintered clay may be cooled to room temperature to be mixed with at least one material selected from the group consisting of plant activators, grains, plant residues, food residues, wastewater residues, nucleic acids, iron sulfate, oyster shells, scallop shells, baking soda, oil residues, soybean flour, rock salt, sea salt, spices (e.g., cinnamon), cacao, coffee, fragrances (e.g., fragrant wood), aroma oils, charcoal, peat moss, coco peat, corn cobs, vermiculite, pearlite, clay powder (e.g., kaolin), various minerals (e.g., illite, mica, silica, calcium carbonate, and powder such as rocks and gravel), fulvic acid, fumic acid, microorganisms such as nitrifying yeast, and microbial extracts (e.g., enzymes).

### Use of Granulated Sintered Clay as Water-Quality Improving Agent, Water Purifying Agent, or Water-Contamination Inhibiting Agent

The granulated sintered clay in the present technology can be used in a water-quality improving agent, water purifying agent, or water-contamination inhibiting agent. Any appropriate amount of granulated sintered clay may be placed in water. For example, the granulated sintered clay is placed in an amount of 3 mass % to the amount of water. The granulated sintered clay in the present technology enables not only to produce high-quality water suitable for agricultural and horticultural uses and to purify wastewater, but also to readily purify a large volume of water just by placing the clay into eutrophicated and polluted lakes or marshes and rivers (fresh water) and sea (seawater). For example, the granulated sintered clay in the present technology can be applied to sea to maintain the food chain in water in a normal state. The food chain in water indicates a cycle where bacteria and fine phytoplankton are responsible for water purification, zooplankton preys on the bacteria and fine phytoplankton, small fish prey on the zooplankton, and big fish prey on the small fish.

The granulated sintered clay in the present technology does not need to be collected or replaced after being immersed into lakes, mashes, rivers, or the sea, because the clay does not contain artificial chemical substances and can be returned to nature without the need of collection.

Alternatively, the granulated sintered clay immersed into water can be collected and regenerated through sun-drying or artificial drying. The granulated sintered clay after collection can be also regenerated through dilution with new granulated sintered clay or raw clay material.

The water-quality improving agent, water purifying agent, or water-contamination inhibiting agent in the present technology may be mixtures or impregnations of appropriately granulated sintered clay with at least one material selected from the group consisting of plant activators, grains, plant residues, food residues, wastewater residues, nucleic acids, iron sulfate, oyster shells, scallop shells, baking soda, oil residues, soybean flour, rock salt, sea salt, spices (e.g., cinnamon), cacao, coffee, fragrances (e.g., fragrant wood), aroma oils, charcoal, peat moss, coco peat, corn cobs, vermiculite, pearlite, clay powder (e.g., kaolin), various minerals (e.g., illite, mica, silica, calcium carbonate, and powder such as rocks and gravel), fulvic acid, fumic acid, microorganisms such as nitrifying yeast, and microbial extracts (e.g., enzymes). The incorporation of the ingredients described above can improve the water quality, and maintain or improve a function of water purification.

The water-quality improving agent or water purifying agent of the present technology can be applied to, for example, purification of factory wastewater, papermaking wastewater, sewage from livestock manure, wastewater from industrial waste treatment plant, food residue, wastewater residue, and can also purify polluted water where blue-green algae and microorganisms propagate.

### Water-Quality Improving Device or Water Cleaning Device

A water-quality improving device or a water cleaning device in the present technology has a module having the water-quality improving agent or the water purifying agent. Any type of module can be used, for example a module filled with the water-quality improving agent or the water purifying agent in a container can be used. This module can be used in, for example, a filter cartridge for a filtration device or a wastewater cleaner. This module can also be placed over the entire bottom of water tank. The use of this water tank for hydroponics, aquaculture and an aquarium does not require replacement of water, but appropriate supplement of the evaporated water.

The water-quality improving device or the water cleaning device in the present technology, for example, has a function where polluted water is poured into a module filled with the water-quality improving agent or the water purifying agent and heated air is bubbled into water to kill germs in the water. Chlorine is generally used to kill germs in water, although the device in the present technology has a sterilizing effect even without use of chlorine. The sterilizing effect can be further enhanced in combination with irradiation with a germicidal lamp.

Specifically, based on the observed values, such as the chemical oxygen demand (COD), the biochemical oxygen demand (BOD) and pH, of the polluted water, a chemical such as a flocculating agent is added to the polluted water followed by stirring. The polluted water is then poured into a container filled with the granulated sintered clay as a filter medium. The values such as COD, BOD, and pH of the filtered water are measured, and a chemical such as baking soda is added based on the observed results, and the mixture is stirred. After stirring, whether the pH reaches neutral is confirmed. An automatic water-quality improving device or a water cleaning device may be manufactured that can measure the values, such as COD, BOD, and pH, and calculate and control the selection of the type and amount of agents to be added based on the observed results in such a series of operations.

For example, a water-quality improving device or a water cleaning device may be manufactured that includes a huge Hume pipe loaded with several types of granulated sintered clay therein such that the particle diameter of the clay gradually decreases from the inlet to the outlet of polluted water. The values such as COD, BOD, and pH of the filtered water discharged from the outlet can be automatically measured as appropriate.

### System Having Water-Quality Improving Device or Water Cleaning Device

The water-quality improving device or the water cleaning device in the present technology can be incorporated into a water quality improving system or water purifying system. The water-quality improving device or the water cleaning device can also be incorporated into a plant cultivation factory system, a hydroponic cultivation system, an isolated system capable of planting or cultivating even in soil-polluted or air-polluted areas, and a so-called aquaponics system for sustainable aquaculture and cultivation that the aquaculture of, for example, fish and shrimp and the cultivation of plants coexist in one system.

Furthermore, a fine bubble technology can be applied to the system described above to utilize the granulated sintered clay in combination with the fine bubble technology in the environmental field and the agricultural and fishery field. The use of the fine bubble technology can further incorporate nano-sized hydrogen and oxygen molecules into the granulated sintered clay.

### EXAMPLES

The present technology will now be described in more detail based on the following examples. It should be noted that these examples are typical examples in the present technology and should not be construed to limit the scope of the present technology.

### Analysis of Raw Clay Material

Raw clay materials mined from three locations beneath volcanic ash of Mt. Haruna (at the foot of Mt. Akagi) were analyzed. The analytical results are shown in Tables 1 to 3. Table 3 shows the results for the raw clay material that was left for a while after mining.

TABLE 1

| Analytical items | | Observed values | | Analytical methods |
|---|---|---|---|---|
| Water content | | 461 | g/kg | Heating weight loss method |
| pH | | 6.7 | | Grass electrode method (21° C.) |
| Ammonium nitrogen | | 3 | mg/kg | Extraction with 2M KCl—successive |
| | | | | distillation method |
| Nitrate nitrogen | | 8 | mg/kg | Extraction with 2M KCl—successive |
| | | | | distillation method |
| Available phosphate | | 10> | mg/kg | Truog's method |
| Cation exchange capacity (CEC) | | 18 | cmol_{c}/kg | Schollen-Berger method |
| Exchangeable | Calcium CaO | 2590 | mg/kg | Extraction with ammonium acetate |
| cations | MagnesiumMgO | 516 | mg/kg | solution—Flame atomic absorption |
| | | | | spectrometry |

TABLE 2

| Analytical items | | Observed values | | Analytical methods |
|---|---|---|---|---|
| Water content | | 499 | g/kg | Heating weight loss method |
| pH | | 6.6 | | Grass electrode method (21° C.) |
| Ammonium nitrogen | | 5 | mg/kg | Extraction with 2M KCl—successive |
| | | | | distillation method |
| Nitrate nitrogen | | 6 | mg/kg | Extraction with 2M KCl—successive |
| | | | | distillation method |
| Available phosphate | | 10> | mg/kg | Truog's method |
| Cation exchange capacity (CEC) | | 23 | cmol_{c}/kg | Schollen-Berger method |
| Exchangeable | Calcium CaO | 3080 | mg/kg | Extraction with ammonium acetate |
| cations | MagnesiumMgO | 694 | mg/kg | solution—Flame atomic absorption |
| | | | | spectrometry |

TABLE 3

| Analytical items | | Observed values | | Analytical methods |
|---|---|---|---|---|
| Water content | | 397 | g/kg | Heating weight loss method |
| pH | | 7.5 | | Grass electrode method (21° C.) |
| Ammonium nitrogen | | 3 | mg/kg | Extraction with 2M KCl—successive |
| | | | | distillation method |
| Nitrate nitrogen | | 3 | mg/kg | Extraction with 2M KCl—successive |
| | | | | distillation method |
| Available phosphate | | 10> | mg/kg | Truog's method |
| Cation exchange capacity (CEC) | | 23 | cmol_{c}/kg | Schollen-Berger method |
| Exchangeable | Calcium CaO | 4940 | mg/kg | Extraction with ammonium acetate |
| cations | MagnesiumMgO | 720 | mg/kg | solution—Flame atomic absorption |
| | | | | spectrometry |

### Production of Granulated Sintered Clay

A cycle including kneading and refinement of the raw cray material was repeated 12 times until agglomerates were substantially found and the raw clay material exhibited a smooth surface even after kneading.

The refined raw clay material was placed in a rotary kiln (RH202B; available from OKAWARA MFG. CO., LTD.), dried at a temperature of 500° C. to 750° C., and granulated, and a portion of silicon dioxide compound contained in the raw clay material was further vitrified for 20 minutes. Another rotary kiln was then used to roughly cool the granulated sintered clay and adjust the particle diameters, and the granulated sintered clay was passed through a sieve to give a particle diameter of up to 15 mm.

### Analysis of Granulated Sintered Clay

The raw clay material was dried, granulated, and vitrified at 700° C. to produce two lots of granulated sintered clays, and the composition of the clay was analyzed by fluorescent X-ray spectrometry (fused glass beads method). Table 4 illustrates the content of each element in the composition on the basis of 100 mass % of the dry soil.

TABLE 4

| Analytical items | Lot 1 (%) | Lot 2 (%) |
|---|---|---|
| Silicon | 50.35 | 56.89 |
| Iron | 9.58 | 8.71 |
| Magnesium | 2.66 | 0.77 |
| Calcium | 2.23 | 2.27 |

### Measurement of Pore Distribution by Nitrogen Gas Adsorption Method

Granulated sintered clays dried, granulated, and vitrified at 500° C., 650° C., and 750° C., respectively, were each subjected to measurement of a differential pore volume (dV/d(log D)) with AUTOSORB-1 available from QUANTACHROME Corp. (a nitrogen gas adsorption method). The results are shown in Table 5. An air-dried product of the raw clay material that had been dried, granulated and not vitrified, commercially available product A (product name: PLATINUM SOIL (JUN Company Limited)), and commercially available product B (product name: DR. SOIL (Kotobuki Kogei Co., Ltd.)) were also subjected to the measurement as comparative examples.

TABLE 5

| | Pore volume (cm³/g) | | | | | |
|---|---|---|---|---|---|---|
| Pore | | | | | Commercially | Commercially |
| diameter | Granulated sintered clay | | | Air-dry | available | available |
| (nm) | 500° C. | 650° C. | 750° C. | product | product A | product B |
| 1.2 | 0.12 | 0.12 | 0.13 | 0.12 | 0.02 | 0.06 |
| 1.5 | 0.13 | 0.13 | 0.10 | 0.13 | 0.02 | 0.06 |
| 1.8 | 0.13 | 0.11 | 0.11 | 0.12 | 0.01 | 0.06 |
| 2.0 | 0.11 | 0.11 | 0.10 | 0.11 | 0.01 | 0.05 |
| 2.3 | 0.10 | 0.11 | 0.11 | 0.11 | 0.01 | 0.05 |
| 2.6 | 0.09 | 0.09 | 0.10 | 0.09 | 0.00 | 0.05 |
| 2.8 | 0.09 | 0.10 | 0.10 | 0.09 | 0.00 | 0.05 |
| 3.0 | 0.09 | 0.09 | 0.07 | 0.08 | 0.01 | 0.05 |
| 3.5 | 0.08 | 0.10 | 0.08 | 0.08 | 0.01 | 0.05 |
| 4.0 | 0.08 | 0.08 | 0.09 | 0.07 | 0.00 | 0.05 |
| 4.5 | 0.07 | 0.07 | 0.08 | 0.07 | 0.01 | 0.05 |
| 5.0 | 0.07 | 0.06 | 0.07 | 0.07 | 0.01 | 0.04 |
| 6.0 | 0.07 | 0.06 | 0.06 | 0.07 | 0.01 | 0.04 |
| 7.0 | 0.07 | 0.07 | 0.08 | 0.07 | 0.01 | 0.04 |
| 8.0 | 0.07 | 0.06 | 0.06 | 0.06 | 0.01 | 0.04 |
| 10.0 | 0.07 | 0.07 | 0.06 | 0.07 | 0.01 | 0.05 |
| 13 | 0.07 | 0.07 | 0.07 | 0.07 | 0.02 | 0.05 |
| 15 | 0.07 | 0.07 | 0.07 | 0.06 | 0.01 | 0.05 |
| 24 | 0.06 | 0.06 | 0.07 | 0.06 | 0.02 | 0.06 |
| >54 | 0.08 | 0.07 | 0.07 | 0.07 | 0.03 | 0.09 |
| >150 | 0.11 | 0.09 | 0.08 | 0.10 | 0.03 | 0.08 |

The granulated sintered clays sintered at 500° C., 650° C., and 750° C., and the air-dried product of raw clay material that had been dried and granulated each had a differential pore volume of 0.06 cm³/g or more at a pore diameter of 10 nm or less and a differential pore volume of 0.08 cm³/g or more at a pore diameter of 4 nm or less. The commercial product A had a differential pore volume of 0.02 cm³/g or less at a pore diameter of 10 nm or less, and the product B had a differential pore volume of 0.06 cm³/g or less at a pore diameter of 10 nm or less.

### Measurement of Hardness

The hardness of the particles of granulated sintered clay was measured by a crushing test under a planar load. The results are shown in Table 6. The hardness was determined as follows: a planar load (gf) was applied to three particles of granulated sintered clay having the same diameter placed on a test table, and a planar load when the particles were crushed was defined as the hardness. The granulated sintered clay exhibited significantly higher hardness than the air-dried product.

TABLE 6

| | Temperature | |
|---|---|---|
| Sample | of sintering | Hardness (g) |
| Dried or granulated | 500° C. | 225 |
| sintered clay | 650° C. | 247 |
| | 750° C. | 260 |

| | |
|---|---|
| Air-dried product | 173 |
| Commercially available product A | 185 |
| Commercially available product B | 222 |

### Specific Surface Area

A specific surface area of the particles of granulated sintered clay was measured with AUTOSORB-1 available from QUANTACHROME Corp. as described above. The results are shown in Table 7. The granulated sintered clay had a specific surface area that is 2 to 9 times higher than that of the commercially available products.

TABLE 7

| | Temperature of | Specific surface area |
|---|---|---|
| Sample | sintering | (m²/g) |
| Granulated sintered | 500° C. | 149 |
| clay | 650° C. | 145 |
| | 750° C. | 143 |

| | |
|---|---|
| Air-dried product | 146 |
| Commercially available product A | 17 |
| Commercially available product B | 79 |

### Analysis of Cation Exchange Capacity

A cation exchange capacity (Schollen-berger method) of granulated sintered clays produced at 470° C. and 750° C. was determined. The granulated sintered clay produced at 470° C. had a cation exchange capacity of 29 cmol_{c}/kg, and the granulated sintered clay produced at 750° C. had a cation exchange capacity of 22 cmol_{c}/kg.

### Electron Microscopic Observation

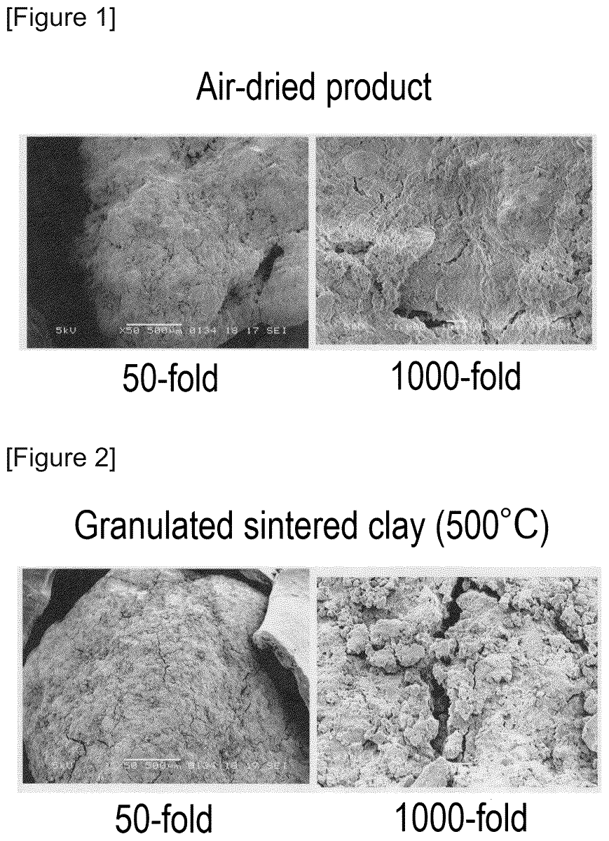

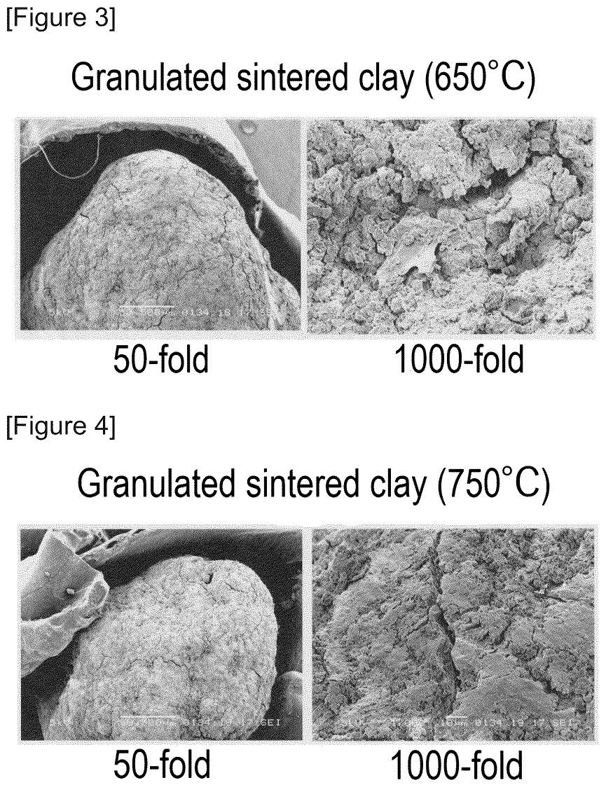

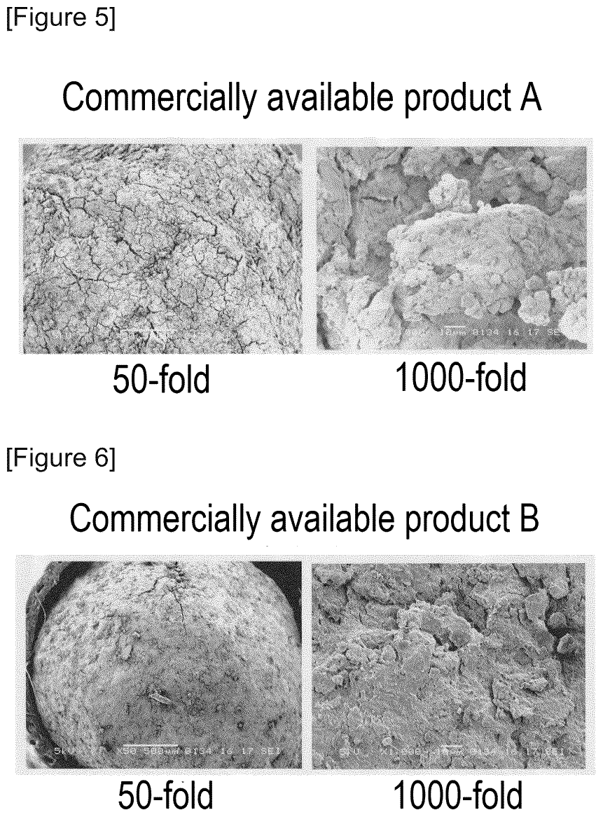

The granulated sintered clay was photographed with a scanning electron microscope JSM-5600LV available from JEOL Ltd. The surface of the sample was coated with gold by vapor deposition in an ion coater IC-50 available from Shimadzu Corporation. The microscopic images are shown in FIGS. 1 to 6. The granulated sintered clay in the present technology had a larger number of finer pores on the particle surface as compared with the commercially available products A and B.

### Immersion Test in Water

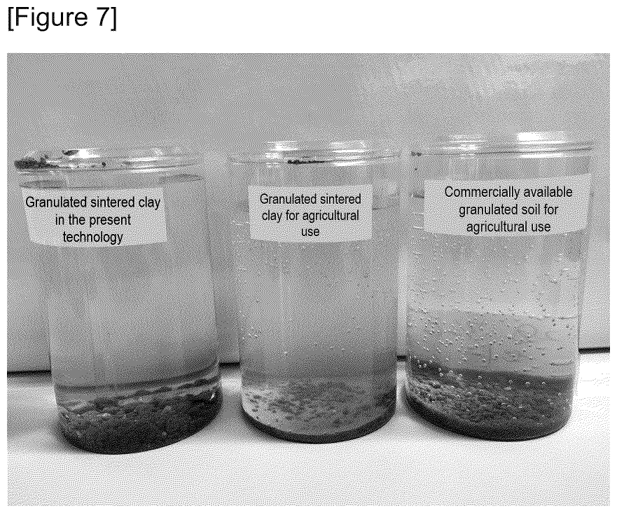

Water (300 ml) was added to the granulated sintered clay in the present technology, the granulated sintered clay for agricultural use, and the commercially available granulated soil for agriculture use (each 10 g), and the mixtures were left for 140 days. FIG. 7 shows the appearances of these samples. The granulated sintered clay in the present technology (the container at the left) maintained its shape and structure without break. The granulated sintered clay for agricultural use (the container at the center) had a lower hardness than the granulated sintered clay in the present technology with break of some of the particles. The particles of the commercially available granulated soil for agricultural use (the container at the right) for comparison were partly broken, and turned green due to algae grew on their surfaces. In addition, a large number of air bubbles were observed on the inner surface of the container in the commercially available granulated soil for agricultural use (the container at the right). Such a large number of bubbles was probably caused by the use of an adhesive such as polyvinyl alcohol (PVA) in the granulated soil.

### Tests of Adsorption Capability and Desorption Capability

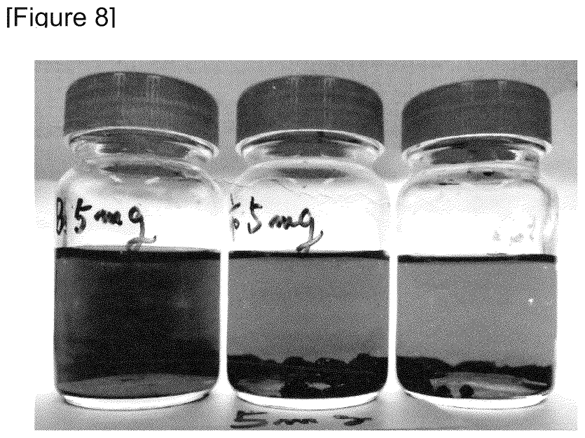

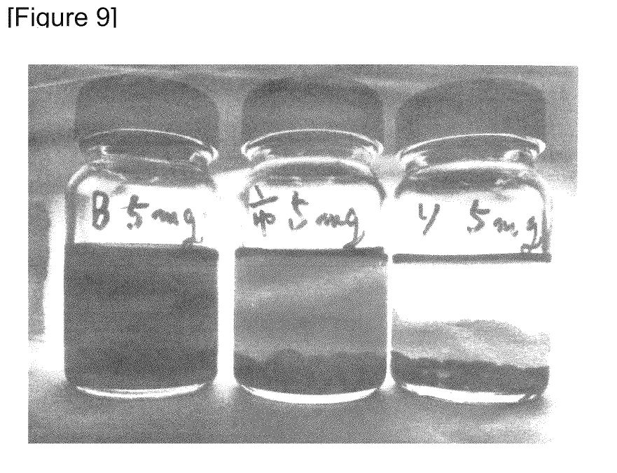

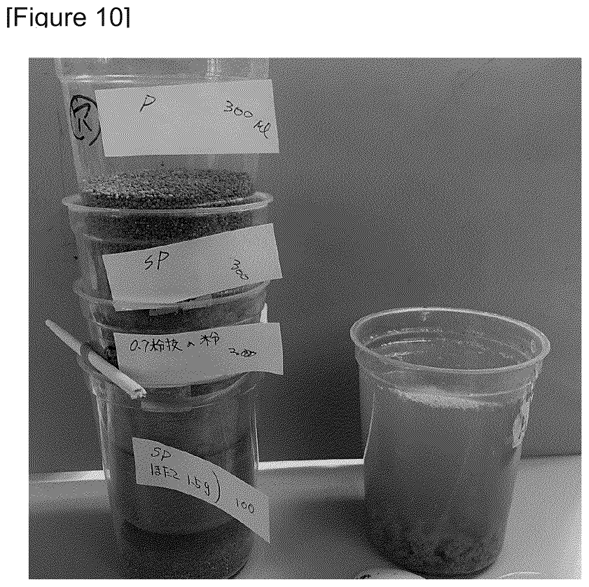

Adsorption capability and desorption capability were tested for the granulated sintered clay with a diluted solution of methylene blue instead of polluted water. Methylene blue (5 mg) in water (30 ml) was placed into vials, and 1 g of granulated sintered clay (sintered at 750° C.) and 1 g of commercially available product (red ball earth from the Kanto loam layer in Tochigi pref., Japan) as a comparative example were added into the respective vials, and the vials were sealed with lids and vertically shaken. These vials were then observed after leaving for two days and five days. FIG. 8 shows the appearances after leaving for two days, and FIG. 9 shows the appearances after leaving for five days. The left vial contains methylene blue only (control), the central vial contains the commercially available product, and the right vial contains the granulated sintered clay.

After leaving for two days, both the vial containing the granulated sintered clay and the vial containing the commercial product had a lighter color of methylene blue than the vial of the control, which results indicated that the granulated sintered clay and the commercial product adsorbed methylene blue. The vial containing the granulated sintered clay (at the right) had a slightly lighter color of methylene blue than the vial containing the commercial product (at the center) (FIG. 8). After leaving for five days, the vial containing the granulated sintered clay (at the right) clearly had a lighter color of methylene blue than the vial containing the commercial product (at the center) (FIG. 9).

### Measurement of Water Quality Purifying Function

Granulated sintered clay (100 g) having a particle diameter of 2.8 mm to 3.5 mm (sintered at 750° C.) was added to raw water (300 ml of water to be purified) and mixed, and the water quality after ten days was analyzed. The chemical oxygen demand (COD) was calculated by multiplying a conversion factor from the potassium permanganate consumption. Phosphate phosphorus (PO₄—P) and ammonium nitrogen (NH₄—N) were measured with PACKTEST available from Kyoritsu Chemical-Check Lab., Corp. The results are shown in Table 8. Ten days after the granulated sintered clay was placed in water, all the values of the COD, phosphate phosphorus, and ammonium nitrogen decreased, which results indicated that the raw water was purified.

TABLE 8

| Observed items | Raw water | Granulated sintered clay |
|---|---|---|
| COD (mg/L) | 7.5 | 2.5 |
| Phosphate phosphorus (mg/L) | 0.05 | 0.02 |
| Ammonium nitrogen (mg/L) | 0.2 | <0.2 |

### Granulated Sintered Clay Containing Charcoal

Powdered charcoal (0.1 mass %) was kneaded with a raw clay material and the mixture was sintered at 700° C. to produce granulated sintered clay containing charcoal. The analytical results are shown in Table 9.

TABLE 9

| Analytical items | | Observed values | | Analytical methods |
|---|---|---|---|---|
| pH | | 6.0 | | Grass electrode method (21° C.) |
| Available nitrogen | | 23 | mg/kg | Extraction with phosphate buffer |
| | | | | at pH 7.0—sulfuric acid decomposition |
| | | | | method |
| Available phosphate | | 10> | mg/kg | Truog's method |
| Cation exchange capacity (CEC) | | 23 | cmol_{c}/kg | Schollen-Berger method |
| Exchangeable | Calcium CaO | 3310 | mg/kg | Extraction with ammonium acetate |
| cations | MagnesiumMgO | 481 | mg/kg | solution—Flame atomic absorption |
| | | | | spectrometry |

### Water Cleaning Device

A water cleaning device was produced with disposable cups. Three cups having several holes in the bottom were prepared and stacked vertically (see FIG. 10). The top cup at the first stage contained 300 ml of granulated sintered clay sintered at 750° C. having a particle diameter of about 0.9 mm to 1.8 mm, the cup at the second stage contained 300 ml of granulated sintered clay having a particle diameter of about 0.2 mm to 0.9 mm, the cup at the third stage contained 200 ml of granulated sintered clay having a particle diameter of about 0.7 mm, and the cup at the fourth stage contained 100 ml of a mixture of granulated sintered clay having a particle diameter of about 0.2 mm to 0.9 mm and 1.5 g of scallop shell powder. Polluted water having a COD of 200 mg/L or more, which was measured with PACKTEST available from Kyoritsu Chemical-Check Lab., Corp. (principle of measurement: oxidation method with potassium permanganate in alkalinity at room temperature), was prepared, and iron sulfate (0.9 g) and scallop shell powder (1.5 g) were added to the polluted water (500 ml), and the mixture was stirred (see the cup at the right in FIG. 10). The polluted water after stirring was poured into the cup at the first stage and was then filtered.

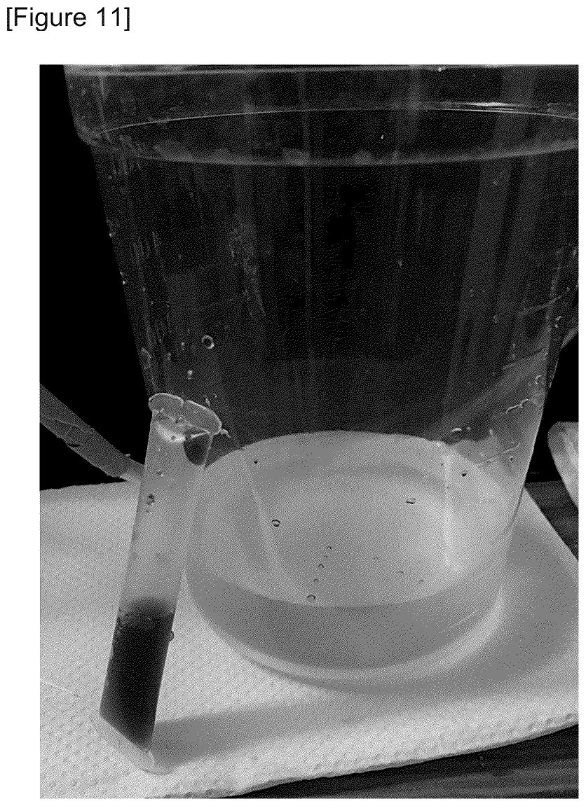

The filtered water is shown in FIG. 11. The COD of the filtered water was measured. The color of an indicator was deep, which result demonstrated that the COD was close to 0 mg/L (see the tube leaning against the cup; a lighter color of the indicator represents a higher COD).

### Soil for Aquaponics

The granulated sintered clay was spread over the entire bottom of the water tank, and aquatic plants and fish were bred and cultivated in the water tank. A container for hydroponics was placed over the water tank. Microorganisms in the water tank decomposed the feces discharged from the fish and feed residues, and the water after the decomposition was used for hydroponics, thereby the plants was able to be grown without fertilization in the hydroponics. In addition, aquatic plants and fish was able to be bred and cultivated merely through water circulation without use of a conventional denitrification device applied in aquaponics or siphons for prevention of water contamination.

### Removal of Blue-Green Algae

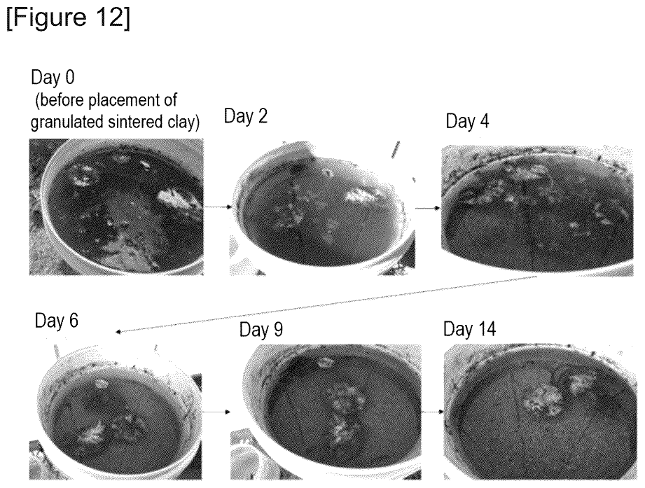

Water was poured into a bucket to generate a large amount of blue-green algae. The granulated sintered clay was placed into the bucket until the bottom of the bucket was hidden. The changes over time are shown in FIG. 12. Before the placement of the granulated sintered clay, blue-green algae were bred throughout the water, but two days after the placement, the water was purified to the extent that turbid water remained. After four days and six days, the turbidity of the water decreased. After nine days, the water was purified to the extent that the granulated sintered clay was able to be clearly seen on the bottom of the bucket, and after 14 days, the water was further purified.

### Removal of Blue-Green Algae in Lotus Field

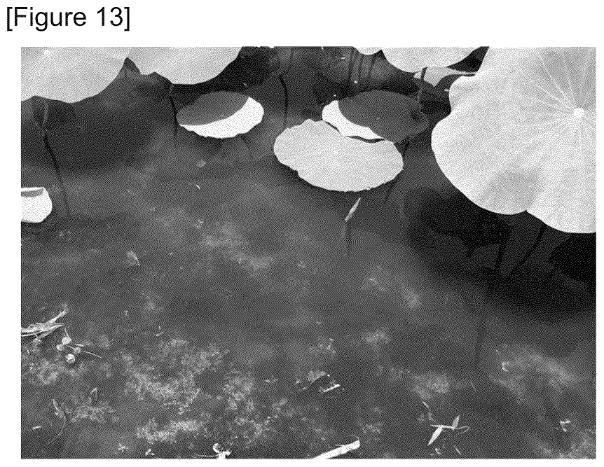

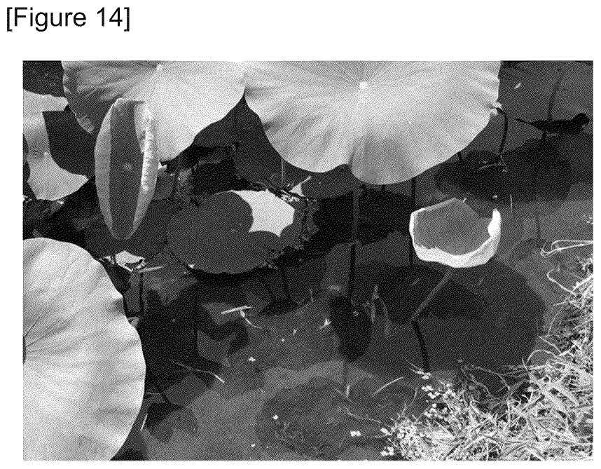

The granulated sintered clay was spread in a lotus field where a large amount of blue-green algae was generated to evaluate the effects of removal of blue-green algae. FIG. 13 illustrates a lotus field before the granulated sintered clay was spread. FIG. 14 illustrates a lotus field four days after the granulated sintered clay was spread. In the lotus field in FIG. 14, the blue-green algae were evidently removed.

### Hardness Measurement of Granulated Sintered Clay After Immersion in Water

Granulated sintered clay was produced with an average particle diameter of approximately 1.5 mm. The hardness of the granulated sintered clay in its dry state before immersion in water was 375 gf (see FIG. 15, photographed on Mar. 22, 2024). After 168 hours of immersion in room temperature water, the granulated sintered clay had a hardness of 72 gf (see FIG. 16, photographed on Mar. 22, 2024). After 10 years of immersion in room temperature water, the granulated sintered clay had a hardness of 17 gf (see FIG. 17, photographed on Mar. 22, 2024). FIGS. 15, 16 and 17 show the granulated sintered clay before (top) and after (bottom) the hardness measurement.

### Observation of the State of Granulated Sintered Clay After Being Left Underwater for a Long Period of Time

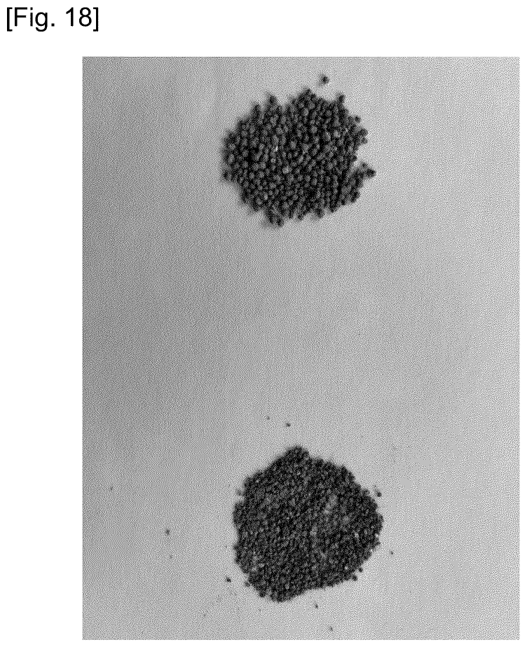

In December 2013 and March 2024, the state of the granulated sintered clay was observed after leaving it in water for a period of time (see FIGS. 18-20 and 21-23, photographed on Mar. 15, 2024).

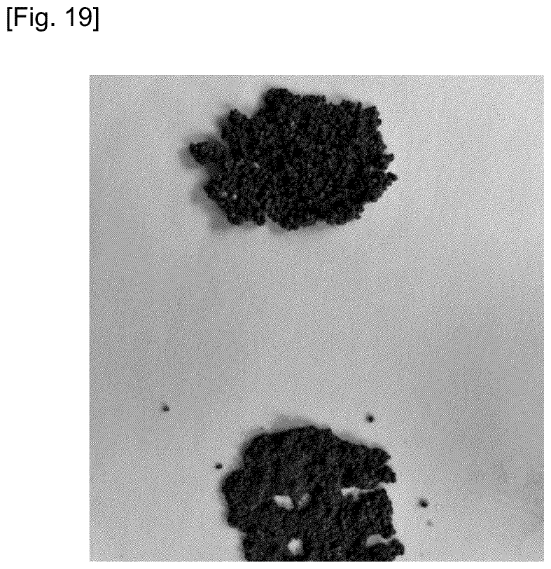

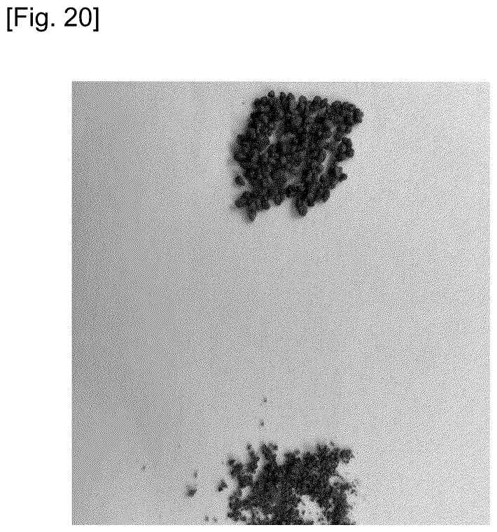

FIG. 18 shows that the granulated sintered clay maintains its shape even after being left in the water tank for about 10 years. FIG. 19 shows that even if the granulated sintered clay is left in the tank for about 10 years, it maintains its shape even when a force equivalent to scooping it up with hands is applied. FIG. 20 shows that if the granulated sintered clay is left in the tank for about 10 years, it becomes brittle to the extent that it can be easily crushed with fingers.

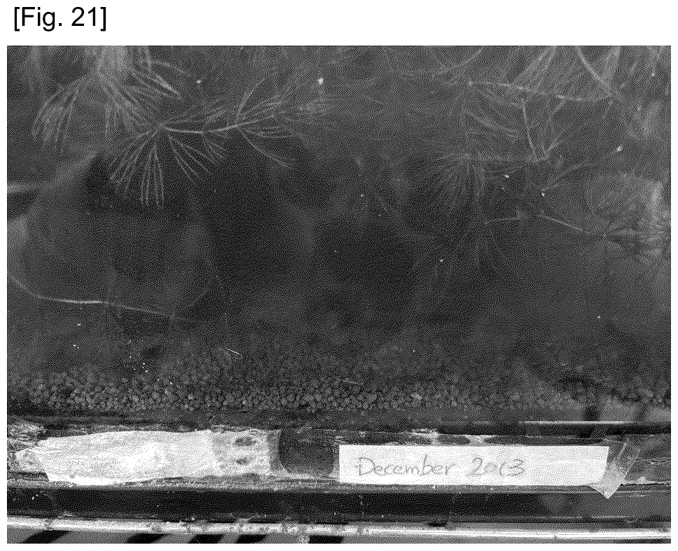

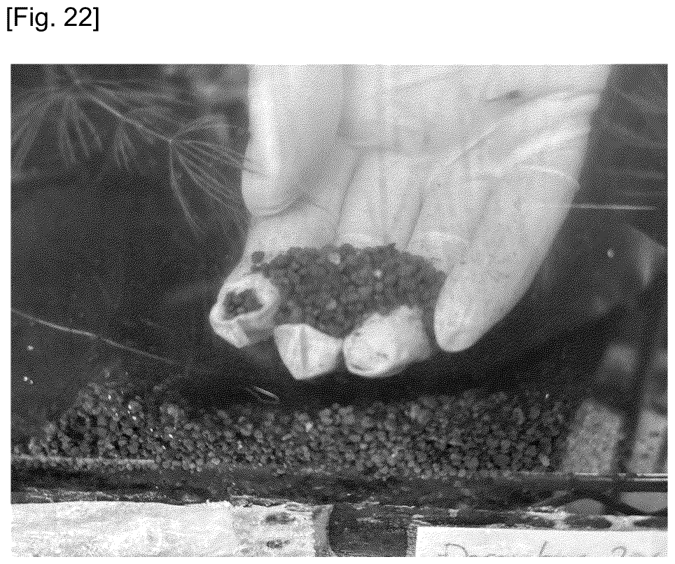

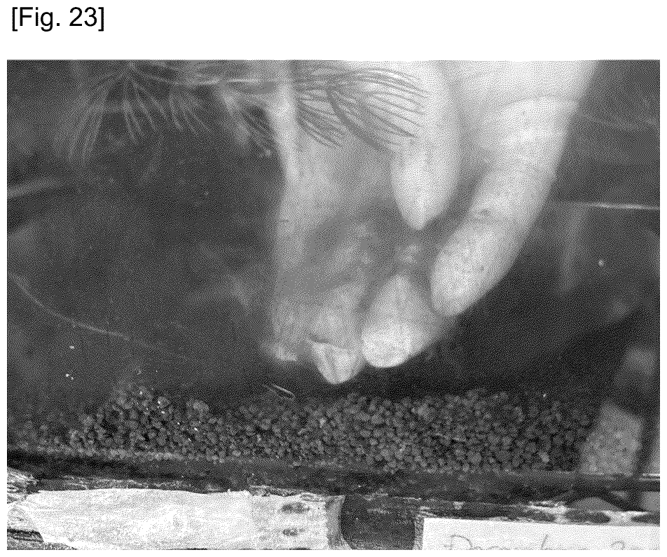

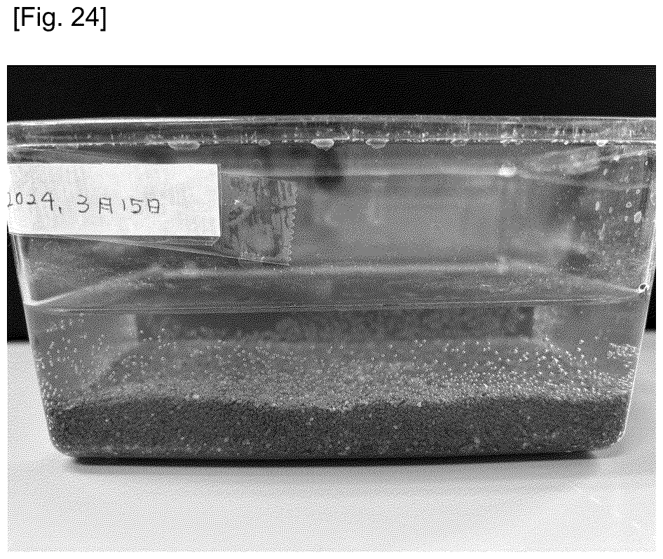

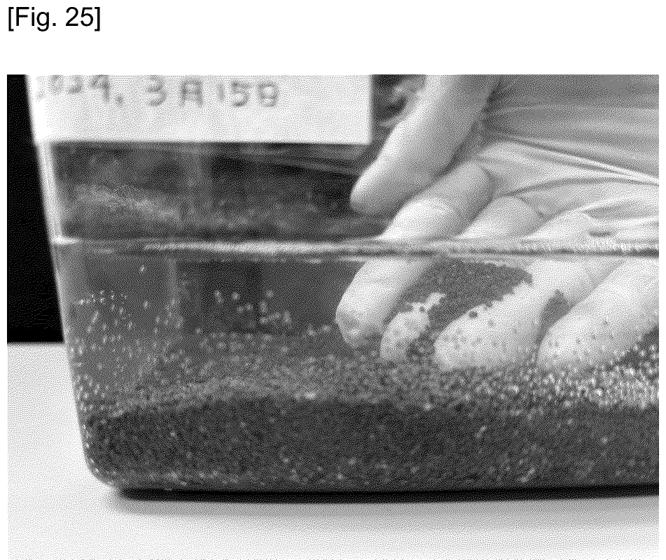

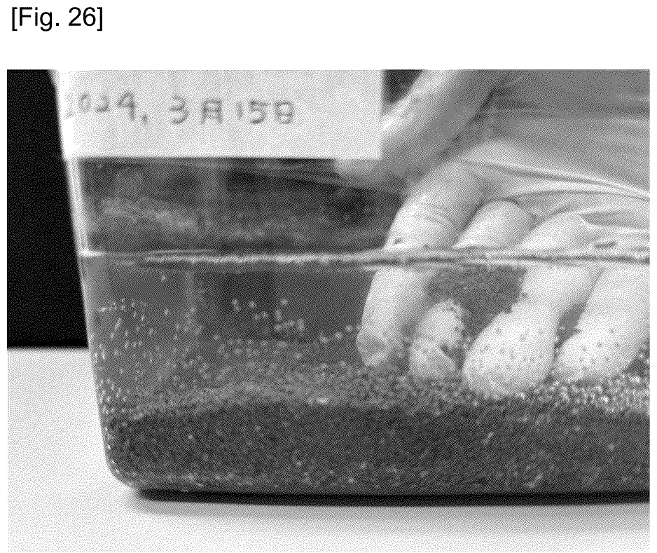

FIG. 21 shows the state of the granulated sintered clay immediately after it was left in water. Bubbles were observed to be forming in the granulated sintered clay. FIG. 22 shows the state of the granulated sintered clay immediately after it was scooped up with hands. FIG. 23 shows the state of the scooped up the granulated sintered clay, which was almost completely unbroken even when it was tried to be crushed with fingers.

The manufacturing method for granulated sintered clay using this technology involves a process of vitrification of only some of the silicon dioxide contained in the raw clay. Therefore, the granulated sintered clay that has been left in water for a long period of time can easily be returned to its original state with the application of a small amount of force.

### INDUSTRIAL APPLICABILITY

According to the present technology, granulated sintered clay can be used in various fields, such as an improvement in water quality, water purification, water cleaner, soil for water tank, and production of mineral water, through application of the superior characteristics in air permeability, water retention, fertilizer retention, and shape retainability in water. The granulated sintered clay can also be used in various industries, such as agriculture with, for example, plant factories and livestock industry with, for example, livestock manure treatment. Since water does not contaminate in the present technology, a plant factory system that needs no drainage and water circulation can be constructed, which can contribute to the preservation of water resources. Furthermore, another application of the granulated sintered clay in the present technology includes a preventive process of evaporation of water from the ground by placement of fine particles of granulated sintered clay over drought regions.

1. Granulated sintered clay with an aggregate structure having pores, wherein
a differential pore volume of pores with a pore diameter of 10 nm or less being 0.06 cm³/g or more;
a hardness being 180 gf to 1200 gf, and
a silicon dioxide content being 35 mass % to 95 mass %,
wherein some portions of the silicon dioxide content are vitrified.

2. The granulated sintered clay according to claim 1, further comprising: a specific surface area of 80 m²/g or more.

3. The granulated sintered clay according to claim 1, wherein the pores are through-pores.

4. The granulated sintered clay according to claim 1, further comprising: a mean particle diameter of 0.075 mm to 9.5 mm as measured in accordance with Japanese Industrial Standards (JIS) A 1204: 2009.

5. The granulated sintered clay according to claim 1, further comprising: a calcium oxide content of 2000 mg/kg or more.

6. The granulated sintered clay according to claim 1, further comprising: a magnesium oxide content of 250 mg/kg or more.

7. The granulated sintered clay according to claim 1, further comprising: a cation exchange capacity of 10 cmol_{c}/kg or more.

8. The granulated sintered clay according to claim 1, wherein the granulated sintered clay includes at least one material selected from the group consisting of plant activators, grains, plant residues, food residues, wastewater residues, nucleic acids, iron sulfate, oyster shells, scallop shells, baking soda, oil residues, soybean flour, rock salt, sea salt, spices, cacao, coffee, fragrances, aroma oils, charcoal, peat moss, coco peat, corn cobs, vermiculite, pearlite, clay powder, minerals, fulvic acid, fumic acid, nitrifying bacteria, yeast, and microbial extracts.

9. A method of manufacturing granulated sintered clay with an aggregate structure having pores, comprising the steps of:
kneading a raw clay material having a silicon dioxide content of 35 mg/kg to 95 mg/kg when the granulated sintered clay is manufactured to homogenize particles of the clay until the raw clay material exhibits a smooth surface;
removing the agglomerates separated or generated during the step of kneading to refine the raw clay material;
granulating the refined raw clay material through dry-granulation to form granulates with the aggregate structure; and
heating the granulated clay material to 400° C. to 1000° C. to vitrify a portion of the silicon dioxide,
wherein the granulated sintered clay has a differential pore volume of 0.06 cm³/g or more with a pore diameter of 10 nm or less, and a hardness of 180 gf to1200 gf.

10. The method for manufacturing granulated sintered clay according to claim 9, wherein fine powder clay is not added to the granulated sintered clay.

11. A water-quality improving agent, a water purifying agent, or a water-contamination inhibiting agent comprising the granulated sintered clay according to claim 1.

12. A water-quality improving device or a water cleaning device comprising a module filled with the water-quality improving agent, the water purifying agent, or the water-contamination inhibiting agent according to claim 11 in a container.

13. A cultivation or culture system having the water-quality improving device or the water cleaning device according to claim 12.
